(19) United States
(12) Patent Application Publication
(10) Pub. No.: US 2016/0276655 A1
(43) Pub. Date: Sep. 22, 2016

(54) ELECTRICAL ENERGY STORAGE DEVICE

(71) Applicant: KAWA INVEST GMBH, Luzern (CH)

(72) Inventor: Syed Safdar ABBAS, Mina al Arab (AE)

(73) Assignee: KAWA Invest GmbH, Luzern (CH)

(21) Appl. No.: 14/910,020

(22) PCT Filed: Jul. 25, 2014
(86) PCT No.: PCT/EP2014/066074

§ 371 Date: Feb. 4, 2016

(30) Foreign Application Priority Data
Aug. 7, 2013 (CH) 01360/13
Feb. 19, 2014 (EP) PCT/EP2014/053238

(51) Int. Cl. H01M 4/36; H01M 4/587; H01M 4/60; H01M 2/16; H01M 4/62

(52) U.S. Cl. CPC H01M 4/364; H01M 2/1646; H01M 4/366; H01M 4/625; H01M 4/602; H01M 4/587; H01M 2004/028

(57) ABSTRACT

An electrical energy storage device (1) is provided that is made at least partly on the basis of silk. The electrical energy storage device (1) comprises a cathode (3) which is at least partly based on silk carbon paste produced by mixing fibroin carbon powder with liquid sericin paste.

### TECHNICAL FIELD

The present invention relates to an electrical energy storage device, such as in particular an electrical battery, according to the preamble of claim 1 and to a method for producing the same. In particular, the present invention relates to an electrical battery based at least on silk as the raw material, and to a method for producing the same.

One of the most important aspects in satisfying daily needs, in particular while taking environmental issues into consideration, is that of the efficient storage of energy, in particular electrical energy. A wide variety of batteries are available for electrical energy storage and the efficiency and storage capacity of these batteries are being improved. At the same time, the ecological aspect is often neglected, with the effect that batteries generally have to be disposed off as what is known as hazardous waste. An important aspect here is particularly the batteries known as rechargeable batteries.

### PRIOR ART

WO 2013/018843 discloses a battery having an oxygen gas diffusion electrode with a catalyst comprising silk-derived activated carbon. The silk-derived activated carbon is manufactured by subjecting raw silk to several steps of baking and heating.

U.S. Pat. No. 3,918,989 describes the production of a flexible electrode plate in which the active electrode material is bound by means of a water-soluble resin containing fibroin.

In the accumulators presented in GB 796,410, it is proposed to use an insulator made of natural silk between the electrodes.

### SUMMARY OF THE INVENTION

An object of the present invention is to provide an electrical energy storage device with an improved ecological and economic efficiency.

A further object is to propose a rechargeable energy storage device that can be recharged efficiently and quickly.

Finally, the energy storage device should be made from raw material which is as environmental friendly as possible.

The object is achieved according to the invention by means of an energy storage device according to the wording of claim 1 and by means of an energy storage device produced according to the method as specified in claim 9.

Proposed is a storage device for electrical energy based on silk, a natural material that is produced by insects, that is to say the silk or mulberry moth—often known as the silkworm or, with its latin name, Bombyx Mori. As is known, the silk thread consists from a chemical viewpoint of the long-chain protein molecules fibroin (70-80%) and sericin (20-30%). Fibroin is a β-keratin with a molecular weight of 365,000 kDa. Sericin is also referred to as silk gum.

The recurring sequence of the amino acids in the fibroin is Gly-Ser-Gly-Ala-Gly-Ala (see FIG. 1).

Thus, the present invention provides an electrical energy storage device, particularly a battery, with a cathode. The cathode is at least partly, in particular mainly, based on silk carbon paste produced by mixing fibroin carbon powder with liquid sericin paste. Thus, the cathode is made of a mixture of fibroin carbon powder and of liquid sericin paste and of optional further components, such as particularly a coating, preferably a carbon nano coating, applied to the silk carbon paste.

The cathode is the electrode of the electrical energy storage device which is electrochemically reduced during the discharge process of the electrical energy storage device or battery. Thus, during the discharge process, the cathode represents the positive terminal, while the anode represents the negative terminal.

To produce what is referred to as the silk carbon paste, first the fibroin and sericin must be separated from the raw silk. In order to separate the fibroin (pure silk) from the sericin (silk gum), usually the raw silk yarn is boiled. After this process step, which can also be referred to as the scouring process, the sericin is left behind as a liquid paste and is required later in the process for the further production of the storage cell. Then the fibroin is heated at a high temperature of 800° C. and is preferably subjected to this temperature for approximately one hour before being cooled down to a temperature of approximately 60° C. This results in carbon in a pulverized form, being referred to as fibroin carbon.

The separation of fibroin and sericin is a process that is very well known to the skilled person and in particular in the textiles industry and does not have to be explained in any more detail at this point.

With the aid of a machine known as a slurry mixer machine, which is used in the industrial production of batteries, the fibroin carbon powder is mixed with the liquid sericin paste until a soft homogeneous mass is obtained, being referred to as silk carbon paste. The slurry mixer machine is a centrifuge, which moves the fibroin carbon at a very high speed and at the same time initiates or adds the sericin by means of an injection having an approximate ratio of about 75% fibroin and about 25% sericin (vol %).

The silk carbon paste of the cathode is usually coated with a coating material. The coating material normally constitutes the active cathode material involved in the electrochemical processes of the energy storage device. Thus, the silk carbon paste particularly has the function of a carrier material for the active cathode material in this case.

In a preferred embodiment, carbon nanotubes and particularly graphitized carbon nanotubes are used as the coating material for the cathode. The production of carbon nanotubes is well known to the person skilled in the art. Carbon nanotubes have the advantage of being electroconductive and of being able to carry a high electric current density, which results in a high energy density of the electrical energy storage device. In addition, carbon nanotubes represent an extraordinarily stiff and hard material.

The use of silk carbon paste as the carrier for the active cathode material results in an electrical storage device having excellent properties as concerns the discharging and recharging cycles as well as the loading capacity. Due to the large and porous surface which is usually provided by the silk carbon paste, a fast and efficient electrochemical reaction takes place at the cathode.

In a preferred embodiment, the electrical energy storage device comprises a zinc plate as the anode. Advantageously, the active material of the cathode is carbon in this case. Thus, the silk carbon paste of the cathode is advantageously coated with a carbon material, in particular carbon nanotubes. Accordingly, the electrical energy storage device would have the underlying electrochemical functioning of a zinc-carbon battery in this case. The electrolyte used can be a solution of ammonium chloride NH₄Cl as in conventional zinc-carbon batteries. Of course, other kinds of electrolytes are feasible for use in the electrical energy storage device. In alternative embodiments, the anode could also be made of copper, silver, gold or magnesium, and corresponding materials would then be chosen for the coating of the cathode and the electrolyte.

The insulator (also called separator) between the cathode and the anode of the electrical energy storage device can be based on cellulose, nonwoven fibres or polymer films, such as in conventional batteries. Preferred, however, is the use of a MICA insulator. More preferably, the insulator is made of muscovite MICA. In this case, a sheet of muscovite MICA is arranged between the cathode and the anode. Muscovite MICA is particularly heat resistant.

MICA is a latin word, meaning crumb. The insulator can be a common MICA Singlass MICA or potash MICA which is called muscovite MICA. The composition is KMg₃Si₃AlO₁₀(OH)₂ having a melting temperature of about 900° C.

For the production of the electrical energy storage device, or the electrical battery, all three component elements, i.e. the cathode, the insulator and the anode, which are advantageously each in the form of a sheet, are preferably laid on top of each other and pressed together under pressure in a pressing machine. The pressing pressure has the effect that the component elements are permanently bonded together to form a battery cell. The battery cell obtained can then be cut appropriately to size.

A number of battery cells produced in this way may for example be connected in series to form an electrical energy storage module or be joined together to form a battery pack.

Such an electrical energy storage module or battery pack consists of at least two battery cells each of which forms an electrical energy storage device as described. Thus, this battery pack also comprises at least two cathodes of silk carbon paste. Two or more battery cells can be connected in series, in order to achieve a higher total voltage, or in parallel, in order to enhance the capacity of the battery pack. It is even possible to connect a first partial battery pack comprising several battery cells connected in series in parallel to a second partial battery pack that also comprises several electrical energy storage devices or battery cells connected in series. In doing so, an electrical energy storage device with an arbitrary total voltage and capacity can be produced.

To increase the battery capacity, further battery packs may be connected in parallel, as described below with reference to specific exemplary embodiments.

The cathode and/or the anode do not necessarily have the form of a sheet and/or need to be in solid form. In alternative embodiments, they could also be in the form of a liquid, powder or gel. The cathode and/or anode and/or electrolyte and/or insulator can be made in nano technology. In a possible further embodiment, the cathode, the anode and the insulator, together with the electrolyte,could be provided in a vacuum atmosphere.

The advantage of the energy storage devices or batteries proposed according to the invention is primarily that a 100% natural product that does not have negative environmental impacts, in particular including during possible disposal of the battery, is used as the raw material for production. Moreover, a rechargeable battery that can be recharged in a very short time can be produced.

### SHORT DESCRIPTION OF THE FIGURES

The invention is now explained in more detail by way of examples and with reference to the accompanying figures, in which:

FIG. 1 schematically shows a detail of the chemical structure of raw silk;

FIG. 2 schematically shows an electrical battery cell according to the invention in cross section;

FIG. 3 schematically shows the battery cell from FIG. 2 in a perspective view;

FIG. 4 shows a battery pack consisting of nine individual battery cells according to FIG. 2 connected in series in longitudinal section;

FIG. 5 schematically shows two parallel-connected battery packs according to FIG. 4 in a perspective view;

FIG. 6 schematically shows a battery pack consisting of a multiplicity of battery cells according to FIG. 2 connected in series in a perspective view; and

FIG. 7 shows a flow diagram illustrating the method steps involved in the production of a cathode of an electrical battery cell according to the invention.

### DESCRIPTION OF PREFERRED EMBODIMENTS

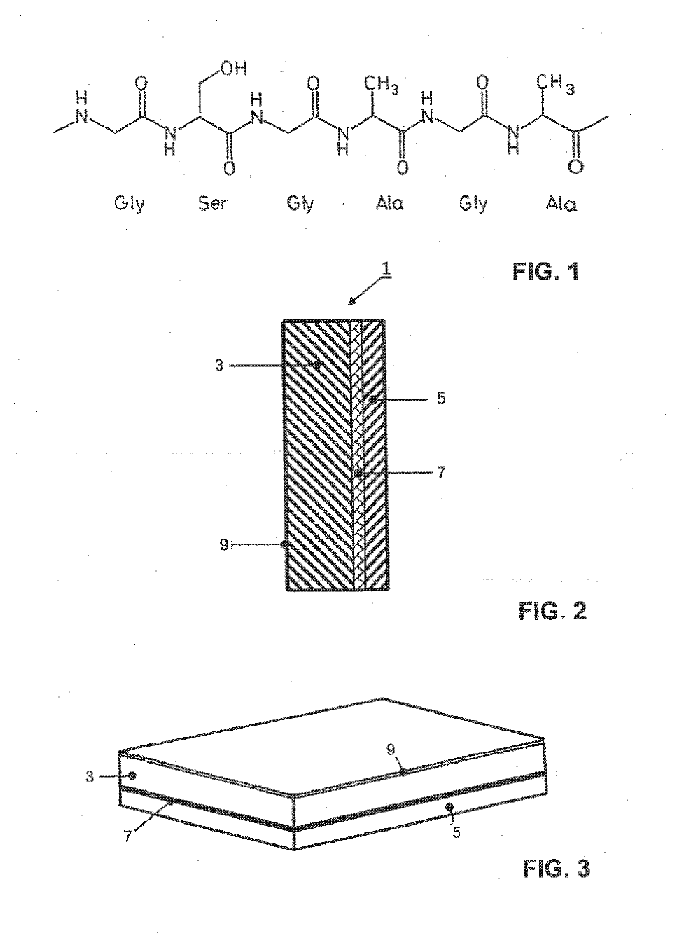

FIG. 1 schematically shows a detail of the chemical structure of the amino acid that is contained in fibroin.

FIG. 2 shows a battery cell 1 in cross section, formed by the silk carbon paste cathode 3, the zinc plate 5, forming the anode, and also the insulator or separator 7 in the form of a muscovite MICA sheet arranged in between. The cathode 3 and the anode 5 are covered by a casing or body 9. This may for example be a 4.5 V battery cell.

FIG. 3 shows the same battery cell 1 in a lateral perspective view.

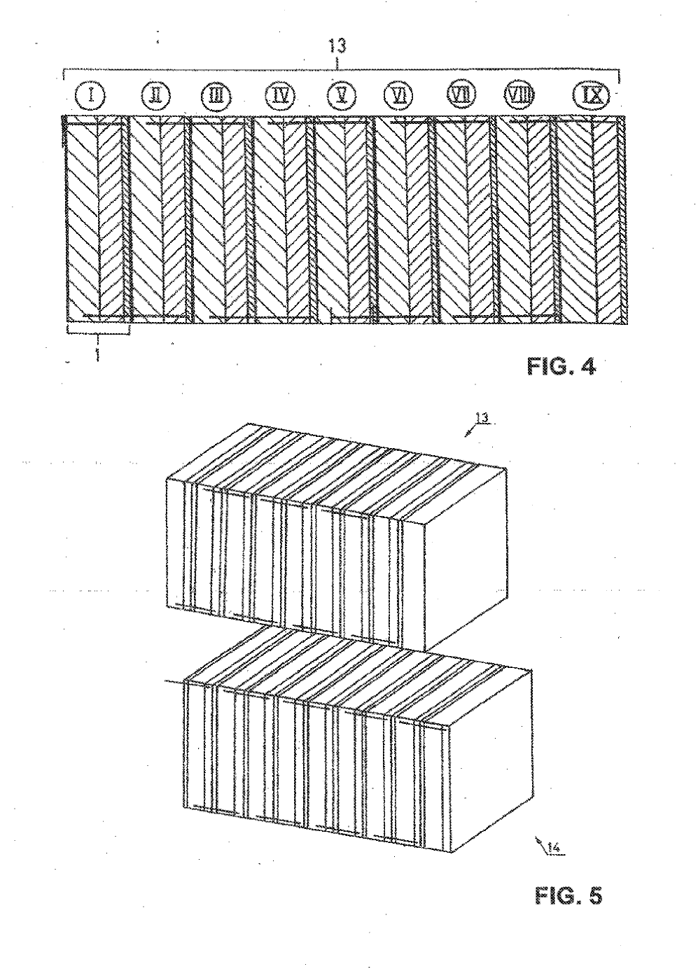

Such battery cells 1, each of which forms an electrical energy storage device for itself, may be connected in series to form an electrical energy storage device or be joined together to form a battery pack 13, consisting for example of the nine individual battery cells I-IX presented, as schematically represented in longitudinal section in FIG. 4. The casing or body 9 of each cell 1 is used to separate the individual battery cells I-IX from each other.

Using the individual battery cell 1 presented in FIGS. 2 and 3, of for example 4.5 V, a battery pack 13 of 40.5 V is consequently obtained, if 9 individual battery cells 1 are connected in series.

The thickness of the zinc plate 5 may be for example 4 mm and that of the cathode 3 (silk carbon paste+carbon nanotubes) per battery cell 1 may be for example about 10 mm. The insulator 7 may have a thickness for example of 1 mm, and the casing or body 9 may have a total thickness for example of 6 mm per battery cell 1. A complete cell 1 with 4.5V is consequently provided with dimensions of various sizes, e.g. 42×68×21 mm.

The weight per cell 1 can vary, but is in the present embodiment generally about 166 g, whereby the battery is provided with a total weight of about 3 kg.

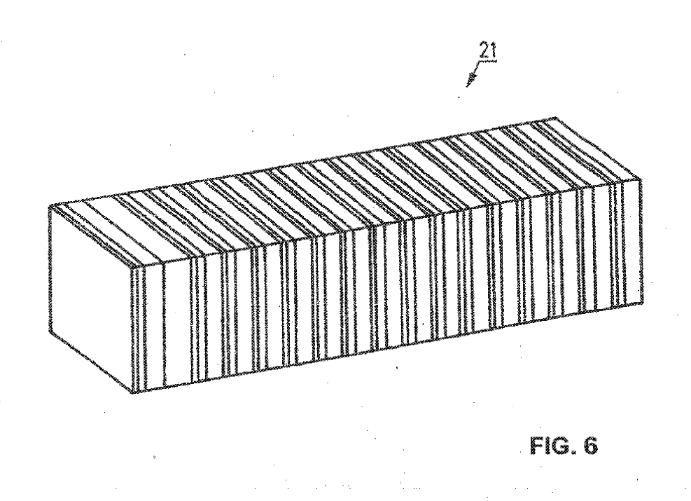

The battery pack 13 presented with reference to FIG. 4 may for example be connected in parallel to form a further analogous battery pack, in order for example to achieve a doubling of the ampere hours (Ah). Consequently, the electrical energy storage device that is schematically represented in a perspective view with reference to FIG. 5, consisting of the two packs 13 and 14. An electrical battery produced in this way is then ready for charging, which provides a capacity of 46.8 V/10 Ah. Thus, the electrical energy storage device concerning an energy storage array, as represented in FIG. 5, is suitable for forming a rechargeable electrical battery. The example described with reference to FIG. 5 was able to be charged completely within 13 minutes.

In a field trial, an electric vehicle in the form of an electric tricycle without pedals was powered by a battery according to the invention, achieving the following result:
Date: 7 Dec. 2012;
Location: Dubai;
Air temperature: 25° C.;
Terrain: asphalt, circuit without gradients (800 m in length);
Travelling weight: 85 kg;
Motor data: 48V/500 W;
Top speed: 28 km/h;
Distance covered until complete discharge: 25 km;
Battery type: 46.8 V/10 Ah (FIG. 5);
Charging time before test run: 13 minutes;
Charging time after test run: 13 minutes.

In FIG. 6, finally, by analogy with FIG. 4, an individual battery pack 21 is schematically shown in a perspective view, having 18 individual battery cells 1, as represented for example in FIG. 2.

A further electrical battery produced according to the invention gave the following technical data:
Maximum operating voltage: 100 V;
Maximum power capacity in Watts: 2,000 W/h;
Power/weight: Wh/kg about 370 Wh/kg;
Battery dimensions for 46.8 V/10 Ah: 198×84×68 mm;
Nominal discharge current: 10-15 amperes;
Maximum discharge current: 50-60 amperes;
Charging time: 10 to 15 minutes;
Estimated number of charging cycles: about 10,000;
Estimated operational lifetime: at least 15 years;
Operating temperature: −35° C. to +60° C.

Batteries produced according to the invention may be used for example in telecommunications, for driving vehicles, in entertainment electronics, in industry, in residential building (energy storages), in space travel and also for military purposes.

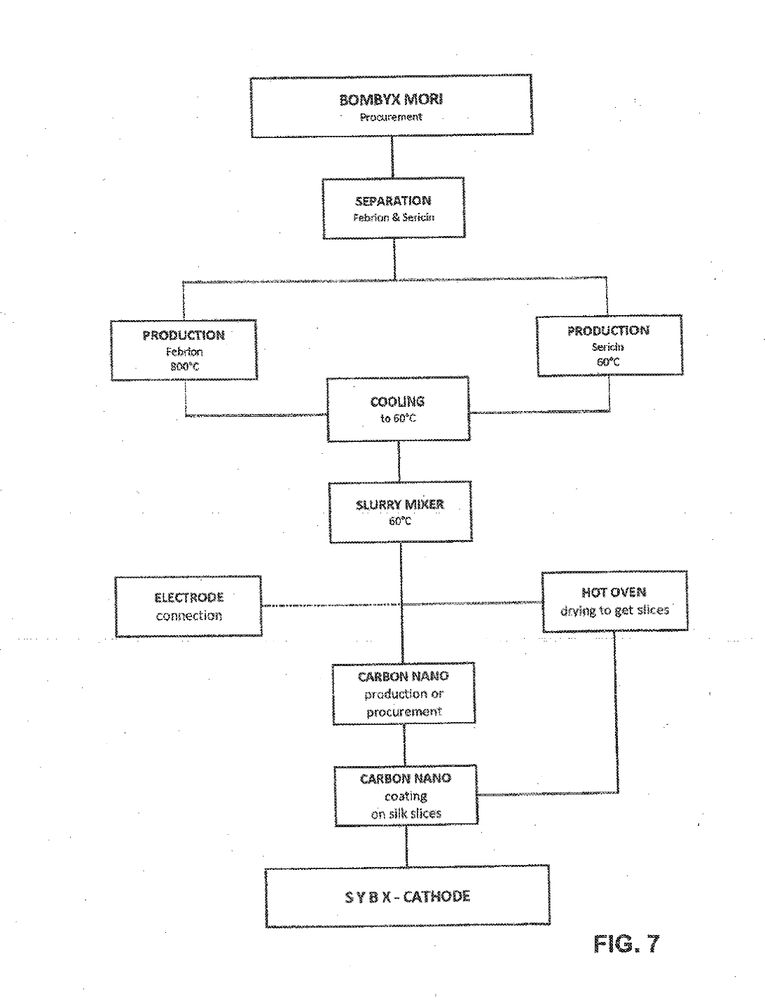

FIG. 7 illustrates the method steps involved in the production of a cathode of an electrical energy storage device according to the present invention:

In a first step, raw silk is procured from the Bombyx Mori by means of methods well known to the skilled person, e.g. from textile industry.

The raw silk is boiled twice for 45 minutes in an aqueous solution of 0.02 MW (molecular weight) Na₂CO₃ (Acros Organics™) and then dialyzed for three days in deionized water in a 3500 MW (molecular weight) cut off membrane. In doing so, the fibroin and the sericin are completely separated from each other.

In order to dry the fibroin, the fibroin is pressed in a pressing machine with various pressures depending on the type of silk fibroin and subsequently stored at a temperature of 60° C. for about 24 hours.

After drying, the fibroin is heated to at least 800° C., preferably to approximately 800° C., and subjected to this temperature in the presence of oxygen for about one hour. After being heated to 800° C., the fibroin is cooled down to approximately 60° C. As a result, fibroin carbon is obtained in a pulverized form.

The sericin, which is floating on the water surface, can be purified by a membrane, in order to obtain the pure sericin. The pure sericin obtained as described is then stored at a temperature of approximately 60° C.

The fibroin carbon and the sericin, both still at a temperature of 60° C., are then mixed together in a slurry mixer machine. The slurry mixer machine mixes both materials, with an approximate ratio of about 75% fibroin and about 25% sericin (vol %), until a homogeneous, dough-like mixture is obtained.

Subsequently, the mixture of fibroin carbon and sericin is filled in a mould and dried in a hot oven at a temperature of approximately 150° C. for about one hour. At the end of this drying and shaping process, one or more slices of preferably firm slices are obtained owing to the shape of the mould.

These slices are coated, preferably on their entire outer surfaces, with carbon nanotubes. For this purpose, graphitized high purity multiwalled carbon nanotubes are preferably produced by a low temperature chemical vapour deposition (CVD) method and subsequently annealed during about 20 hours under the condition of an inert gas and at a temperature between 1,600° C. and 3,000° C. The specifications of the carbon nanotubes, which are preferably used, are as follows:
Multiwalled carbon nanotubes —COOH functionalized;
Purity >99.9% (carbon nanotubes), as measured by means of thermal gravimetric analysis (TGA) and transmission electron microscopy (TEM);
Content of COON: 1.28 Wt %;
Outside diameter: 8.15 nm;
Inside diameter: 3-8 nm;
Length: 50 μm (TEM);
Specific surface area (SSA): >117-120 m²/g;
Color: black;
Ash: 0.1 Wt % (TGA);
Electrical Conductivity: 200 S/cm;
True density: 4.1 g/cm³;
Manufacturing method: CVD, processed at 2800° C.

After the coating, the slices are stored at 60° C. for another 24 hours in a low moisture atmosphere before the coated slices can be used as cathodes for one or several electrical energy storage devices.

The great advantage of the electrical battery produced according to the invention is that it is based to the greatest extent on natural resources, such as silk and zinc. This produces an ecologically important advantage over the batteries, in particular rechargeable batteries, that are known today.

The batteries and the production method presented and described with reference to FIGS. 2 to 7 are of course only examples, for the purpose of providing a better explanation of the present invention. Not only the dimensioning and the use of battery cells but also the structure and arrangement of the battery cells and so on and so forth can be changed or modified in any way desired.

1. An electrical energy storage device with a cathode, wherein the cathode is at least partly based on silk carbon paste produced by mixing fibroin carbon powder with liquid sericin paste.

2. The electrical energy storage device according to claim 1, wherein the silk carbon paste of the cathode is coated with a coating material, in particular with carbon nanotubes.

3. The electrical energy storage device according to claim 1, wherein the electrical energy storage device comprises a zinc plate as the anode.

4. The electrical energy storage device according to claim 1, wherein the electrical energy storage device comprises a MICA insulator.

5. The electrical energy storage device according to claim 4, wherein the insulator is made of muscovite MICA.

6. A battery pack that consists of at least two electrical energy storage devices, each of the at least two electrical energy storage devices comprising a cathode being at least partly based on silk carbon paste produced by mixing fibroin carbon powder with liquid sericin paste.

7. The battery pack according to claim 6, wherein the electrical energy storage devices are connected in series.

8. The battery pack according to claim 6, wherein the electrical energy storage devices are connected in parallel.

9. A method for producing an electrical energy storage device with a cathode, wherein silk carbon paste is produced by mixing fibroin carbon powder with liquid sericin paste, and wherein this silk carbon paste is used for the production of the cathode.

10. The method according to claim 9, wherein raw silk is boiled in order to be separated into fibroin and sericin, then the fibroin is heated to at least 800° C. for the production of the fibroin carbon powder, and the sericin is used for the production of the liquid sericin paste.

11. The method according to claim 9, wherein the production of the cathode further involves coating of the silk carbon paste by means of a coating material.

12. The method according to claim 9, wherein, for the production of the electrical energy storage device, a sheet of muscovite MICA is placed between the cathode and a zinc plate as the anode.

13. The method according to claim 12, wherein the cathode, the sheet of muscovite MICA and the anode are pressed together to form a battery cell of the electrical energy storage device.

14. The method according to claim 9, wherein, to form what is known as a battery pack of the electrical energy storage device, a number of battery cells each comprising silk carbon paste as the cathode, a zinc plate as the anode and also a MICA insulator are joined together in series.

15. (canceled)

16. The electrical energy storage device according to claim 2, wherein the silk carbon paste of the cathode is coated with carbon nanotubes.

17. The method according to claim 11, the coating material being carbon nanotubes.


SEQUENCE LISTING (1 sequence)

SEQ ID NO: 1 - protein, 6 aa, Artificial Sequence
  Synthetic peptide
GSGAGA